(19) United States
(12) Patent Application Publication
(10) Pub. No.: US 2023/0236019 A1
(43) Pub. Date: Jul. 27, 2023

(54) INFORMATION PROCESSING APPARATUS, INFORMATION PROCESSING METHOD, AND INFORMATION PROCESSING SYSTEM

(71) Applicant: SONY GROUP CORPORATION, TOKYO (JP)

(72) Inventor: HIROAKI ADACHI, TOKYO (JP)

(21) Appl. No.: 18/007,157

(22) PCT Filed: Jul. 20, 2021
(86) PCT No.: PCT/JP2021/027161

§ 371 Date: Jan. 27, 2023

(30) Foreign Application Priority Data
Aug. 5, 2020 (JP) 2020-133142

(51) Int. Cl. G01C 21/30; G06T 11/00; G01C 21/36

(52) U.S. Cl. CPC G01C 21/30; G06T 11/00; G01C 21/3602; G01C 21/3667; G06T 2200/24

(57) ABSTRACT

An information processing apparatus according to an embodiment of the present technology includes a first acquisition section, a setting section, a storage, and a display controller. The first acquisition section acquires map information. On the basis of designation of a region that is performed by a user, the setting section sets a content region with which content data is associated. The storage stores therein the set content region and the map information in a state of being associated with each other. The display controller causes the content region to be superimposed on the map information to be displayed. This makes it possible to easily create content that uses position information.

### TECHNICAL FIELD

The present technology relates to an information processing apparatus, an information processing method, and an information processing system that can be applied to creation of content that uses position information.

### BACKGROUND ART

Patent Literature 1 discloses a technology used to correct an error in position information obtained by the Global Positioning System (GPS).

### CITATION LIST

### Patent Literature

Patent Literature 1: Japanese Patent Application Laid-open No. 2000-75013

### DISCLOSURE OF INVENTION

### Technical Problem

Content that uses position information is expected to be continuously widespread, and there is a need for a technology that makes it easy to create content.

In view of the circumstances described above, it is an object of the present technology to provide an information processing apparatus, an information processing method, and an information processing system that make it possible to easily create content that uses position information.

### Solution to Problem

In order to achieve the object described above, an information processing apparatus according to an embodiment of the present technology includes a first acquisition section, a setting section, a storage, and a display controller.

The first acquisition section acquires map information.

On the basis of designation of a region that is performed by a user, the setting section sets a content region with which content data is associated.

The storage stores therein the set content region and the map information in a state of being associated with each other.

The display controller causes the content region to be superimposed on the map information to be displayed.

In this information processing apparatus, a content region is set on the basis of designation of a region that is performed by a user. Further, the set content region is superimposed on map information to be displayed. This makes it possible to easily create content that uses position information.

The information processing apparatus may further include a second acquisition section and an output section.

The second acquisition section acquires accuracy information regarding accuracy of position information acquired by a position sensor.

The output section outputs support information regarding the setting of the content region on the basis of the acquired accuracy information.

The information processing apparatus may further include a generator that generates the accuracy information on the basis of a difference between first position information and second position information, the first position information being set on the basis of the map information, the second position information being acquired by the position sensor at a position, in a real world, that corresponds to the first position information.

The generator may generate the accuracy information on the basis of a difference between path information and the position information, the path information being set on the basis of the map information, the position information being acquired by the position sensor in a path, in the real world, that corresponds to the path information.

The support information may include image information that includes the map information, the image information being used to set at least one of the content region or the path information.

The output section may cause a correction region or a plurality of correction regions to be displayed on the map information in the image information, the correction region being based on the content region input on the basis of the map information, the plurality of correction regions being based on a plurality of the content regions input on the basis of the map information.

The output section may cause a region including the position information to be displayed as the correction region, the position information being likely to be acquired by the position sensor at a position, in the real world, that corresponds to a position situated in the input content region.

When correction regions of the plurality of correction regions overlap, the output section may change at least one of a position or a size of each of the plurality of correction regions in order for the correction regions of the plurality of correction regions to no longer overlap.

The output section may output alert information when correction regions of the plurality of correction regions overlap.

When correction regions of the plurality of correction regions overlap, the output section may cause overlapping regions to be highlighted to be displayed.

When correction regions of the plurality of correction regions overlap, the output section may output information regarding the content data associated with the content region corresponding to a corresponding one of the plurality of overlapping regions.

The output section may output information regarding a scale of the map information.

The output section may cause comparison-target information to be displayed on the image information, the comparison-target information including a set of the path information and the position information, the path information being set on the basis of the map information, the position information being acquired by the position sensor in the path, in the real world, that corresponds to the path information.

The output section may cause the comparison-target information to be superimposed on the map information in the image information.

The content data may include at least one of sound data or image data.

The position sensor may be a GPS sensor.

An information processing method according to an embodiment of the present technology is an information processing method that is performed by a computer system, the information processing method including acquiring map information.

A content region with which content data is associated is set on the basis of designation of a region that is performed by a user.

The set content region and the map information are stored in a state of being associated with each other.

The content region is superimposed on the map information to be displayed.

An information processing system according to an embodiment of the present technology includes a first acquisition section, a setting section, a storage, and a display section.

The first acquisition section acquires map information.

On the basis of designation of a region that is performed by a user, the setting section sets a content region with which content data is associated.

The storage stores therein the set content region and the map information in a state of being associated with each other.

The content region is superimposed on the map information to be displayed on the display section.

### BRIEF DESCRIPTION OF DRAWINGS

FIG. 1 schematically illustrates an example of a configuration of a content creation system according to an embodiment.

FIG. 2 is a schematic diagram used to describe a sound content map.

FIG. 3 schematically illustrates an example of a region setting GUI.

FIG. 4 schematically illustrates an example of the configuration of the content creation system according to another embodiment.

FIG. 5 is a schematic diagram used to describe a GPS accuracy.

FIG. 6 is a block diagram illustrating an example of a functional configuration of the content creation system.

FIG. 7 schematically illustrates examples of a region setting GUI and a path setting GUI.

FIG. 8 is a flowchart illustrating an example of setting a measurement path.

FIG. 9 illustrates an example of the path setting GUI displayed when the measurement path is set.

FIG. 10 is a schematic diagram used to describe another example of setting a measurement path.

FIG. 11 is a schematic diagram used to describe another example of setting a measurement path.

FIG. 12 is a flowchart illustrating an example of GPS measurement.

FIG. 13 is a flowchart illustrating an example of generating accuracy information.

FIG. 14 is a schematic diagram used to describe another example of associating a measurement path with actually measured values.

FIG. 15 is a flowchart illustrating an example of calculating a correction region (a margin region).

FIG. 16 illustrates an example of the region setting GUI displayed when a content region is set.

FIG. 17 is a schematic diagram used to describe another example of calculating the margin region.

FIG. 18 is a schematic diagram used to describe an example in which a plurality of content regions 3 is input.

FIG. 19 is a schematic diagram used to describe processing that can be performed when the correction regions overlap.

FIG. 20 is a schematic diagram used to describe playback with fade-in or fade-out.

FIG. 21 is a schematic diagram used to describe display of a detection region.

FIG. 22 is a schematic diagram used to describe display of comparison-target information.

FIG. 23 is a schematic diagram used to describe display of the comparison-target information.

FIG. 24 is a schematic diagram used to describe display of the comparison-target information.

FIG. 25 is a block diagram illustrating an example of a hardware configuration of a computer.

### MODE(S) FOR CARRYING OUT THE INVENTION

Embodiments according to the present technology will now be described below with reference to the drawings.

[Content Creation System]

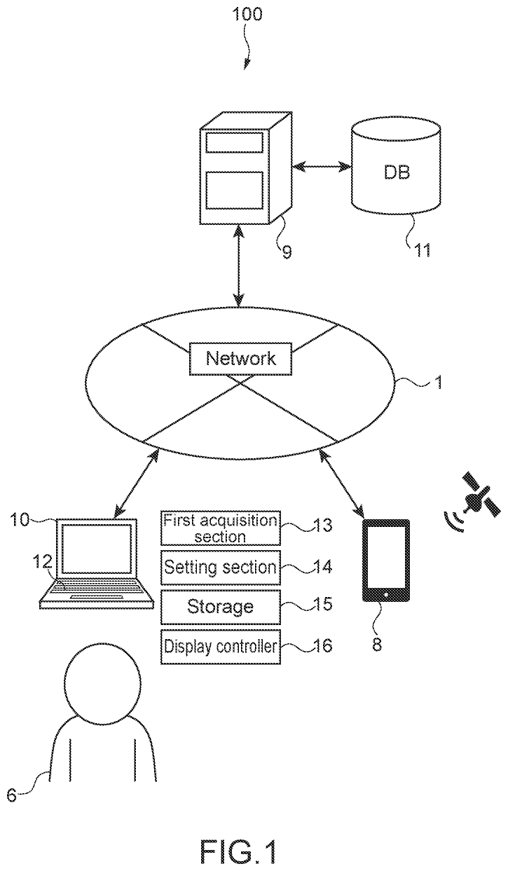

FIG. 1 schematically illustrates an example of a configuration of a content creation system according to an embodiment of the present technology. A content creation system 100 serves as an embodiment of an information processing system according to the present technology.

Further, in the present embodiment, the content creation system 100 serves as a system used to create content that uses position information.

In the following description, a sound content map that plays back, for example, sound, background music, and narration when a content experient (a listener) who is wearing a sound output apparatus such as headphones or earphones enters a specified region, is taken as an example of the content that uses position information. Of course, the application of the present technology is not limited to creation of the sound content map described above.

[Sound Content Map]

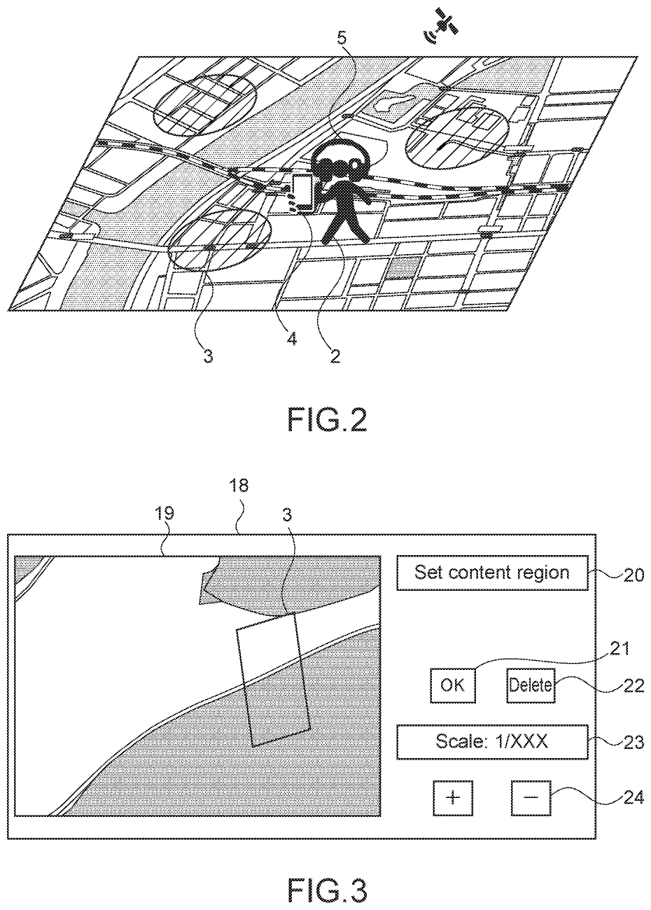

FIG. 2 is a schematic diagram used to describe a sound content map.

The sound content map is content that uses a sound AR system that can provide an auditory augmented reality (AR) experience to a content experient 2.

As illustrated in FIG. 2, sound is virtually arranged in a specified region 3 in a real world. Any sound content such as background music, narration, and a line of a character may be used as sound.

In the present embodiment, an example of a sound content map that is a map on which any sound content such as background music, narration, or a line of a character is arranged, is described. However, the content is not limited thereto. Not only sound content but also non-sound content such as an AR object and an advertisement object may be used. In this case, the content is called, for example, a content map. Further, sound content and non-sound content may be used in combination.

The content experient 2 can listen to the sound arranged in the region 3 by entering the region 3 in the real world.

For example, when the content experient 2 is doing a sightseeing tour on foot in the streets of Ryogoku, the content experient 2 can experience, in the moment of entering the Ryogoku Kokugikan (a sumo hall), virtual content such as narration that explains about the sumo history, or great cheers for sumo matches.

In order to provide the sound content map, content is created and sound is played back. The content is created by a content creator 6. The region 3 is set on the basis of map information, which is a specific example of creating the content. Position information regarding a position of the set region 3 is defined by, for example, a pair of latitude information and longitude information. The region 3 is defined by a pair of latitude information and longitude information of, for example, a peripheral edge, an apex, and the center of the shape of the region 3. Of course, the definition of the region 3 is not limited to being performed using such data.

The creator 6 arranges sound in the set region 3. Specifically, sound content data used to play back sound is associated with the position information regarding the position of the region 3. In other words, a pair of latitude information and longitude information and the sound content data are stored in association with each other.

The region 3 in which sound is virtually arranged, as illustrated in FIG. 2, is hereinafter referred to as a content region 3 that is associated with sound content data, using the same reference numeral. The content region 3 is set by the creator 6.

Note that the creator 6 corresponds to an embodiment of a user according to the present technology.

As illustrated in FIG. 2, sound is played back using a mobile terminal 4 held by the content experient 2 and headphones 5 worn by the content experient 2.

Any device that includes a position sensor that can acquire position information may be used as the mobile terminal 4.

An example in which a GPS sensor is included as the position sensor is described in the present embodiment. The GPS sensor can acquire position information (a pair of latitude information and longitude information) by receiving a GPS signal that is transmitted by a GPS satellite. Of course without being limited thereto, any other position sensor may be included.

For example, an application (an application program) according to the present technology that is used to provide an experience of a sound content map, is installed on a user terminal, such as a smartphone or a tablet terminal, that is held by the content experient 2. This makes it possible to use the user terminal as the mobile terminal 4 used to provide an experience of a sound content map.

Alternatively, a dedicated apparatus used to provide an experience of a sound content map may be provided as the mobile terminal 4 to be lent to the content experient 2.

Any device that can output sound is not limited to the headphones 5, and any other device such as earphones or a head-mounted display may be used.

The mobile terminal 4 detects, for example, the entrance of the content experient 2 into and the exit of the content experient 2 from the content region 3 by comparing position information acquired by a GPS sensor with position information regarding a position of the content region 3 that is set on the map.

When the entrance of the content experient 2 into the content region 3 has been detected, processing of playing back sound content data associated with the content region 3 is performed. This results in outputting, from the headphones 5, sound that corresponds to the sound content data.

When the exit of the content experient 2 from the content region 3 has been detected, processing of stopping playing back sound content data associated with the content region 3 is performed.

For example, when the sound is background music, playback of the background music is stopped, or the background music fades out. When the sound is a line or narration, the playback continues until the line or the like is over, and the playback is stopped when the line or the like is finished.

The present technology is limited to the playback of sound content and the stop of the playback, as described above, and any control may be performed.

The sound content map enables the content experient 2 to obtain a higher-quality virtual experience than ever.

As illustrated in FIG. 1, the content creation system 100 includes a mobile terminal 8, a server apparatus 9, and an information processing apparatus 10.

The mobile terminal 8, the server apparatus 9, and the information processing apparatus 10 are communicatively connected to each other through a network 1.

The network 1 is built by, for example, the Internet or a wide area communication network. Moreover, for example, any wide area network (WAN) or any local area network (LAN) may be used, and a protocol used to build the network 1 is not limited.

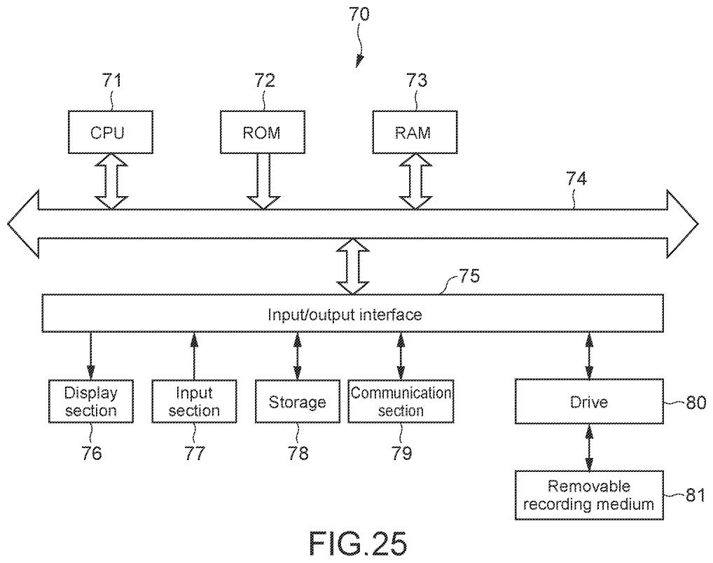

The mobile terminal 8, the server apparatus 9, and the information processing apparatus 10 each include hardware, such as a processor such as a CPU, a GPU, and a DSP; a memory such as a ROM and a RAM; and a storage device such as an HDD, that is necessary for a configuration of a computer. Of course, hardware such as an FPGA or an ASIC may be used (refer to FIG. 25).

For example, an information processing method according to the present technology is performed by, for example, the processor loading, into the RAM, a program according to the present technology that is recorded in, for example, the ROM in advance and executing the program.

The program is installed on the respective devices through, for example, various recording media. Alternatively, the installation of the program may be performed via, for example, the Internet.

The type and the like of a recording medium that records therein a program are not limited, and any computer-readable recording medium may be used. For example, any non-transitory computer-readable recording medium may be used.

For example, each device can be implemented by any computer such as a PC or a smartphone. Of course, the mobile terminal 8, the server apparatus 9, and the information processing apparatus 10 are not limited to having the same configuration as each other.

Any device that includes a position sensor that can acquire position information may be used as the mobile terminal 8. In the present embodiment, a device that includes a GPS sensor. The GPS sensor makes it possible to acquire a pair of latitude information and longitude information regarding the mobile terminal 8 as the position information.

For example, it is assumed that a user terminal is used as a mobile terminal 4 when the sound content map illustrated in FIG. 2 is used. In this case, for example, a device that can achieve a general degree of GPS accuracy is used as the mobile terminal 8. Of course, the configuration is not limited thereto.

It is assumed that a dedicated apparatus is used as the mobile terminal 4 when the sound content map illustrated in FIG. 2 is used. In this case, for example, the dedicated apparatus is used as the mobile terminal 8. Of course without being limited thereto, any other device may be used.

The server apparatus 9 performs various processes regarding creation of a sound content map.

In the example illustrated in FIG. 1, the server apparatus 9 includes a database (DB) 11. The DB 11 may be constructed by a storage device included in the server apparatus 9. Alternatively, the DB 11 may be constructed in an external storage device. In this case, the external storage device can be regarded as part of the server apparatus 9.

The DB 11 stores therein various information regarding the content creation system 100.

For example, map information and information regarding the content region 3 are stored. Further, various information created in the past, history information, and the like may be stored in the DB 11.

The information processing apparatus 10 is used by the creator 6 to set the content region 3. In other words, the information processing apparatus 10 is used as a creator tool.

The information processing apparatus 10 includes a first acquisition section 13, a setting section 14, a storage 15, and a display controller 16 as functional blocks.

The first acquisition section 13, the setting section 14, and the display controller 16 are implemented as software blocks by, for example, a processor executing a specified program. Of course, dedicated hardware such as an integrated circuit (IC) may be used in order to implement the functional blocks.

The storage 15 is implemented by, for example, a memory or a storage device.

The first acquisition section 13 acquires map information.

For example, the first acquisition section 13 acquires pieces of map information regarding various areas from, for example, a map server connected to the network 1. Of course without being limited thereto, map information may be acquired through, for example, a storage medium.

A pair of latitude information and longitude information is associated with map information as position information regarding each point.

The information processing apparatus 10 can cause the acquired map information to be displayed on a display section. Further, the information processing apparatus 10 can acquire position information (a pair of latitude information and longitude information) regarding a point designated by, for example, the creator 6 in map information.

A panoramic image obtained by panoramic image-capturing being performed at each point in the real world may be displayed as map information. For example, a panoramic image or the like that is captured from the Hyakutan dori Street may be displayed as map information. Further, an aerophoto may be displayed as map information.

For example, software used to use map information may be downloaded from, for example, a map server, and this may result in being able to, for example, display the map information, change a scale, and acquire position information regarding each point according to the scale. Alternatively, when an application programming interface (API) used to use map information is published, the map information may become usable by calling the API.

Note that the mobile terminal 8 and the server apparatus 9 can also be used by acquiring the map information.

On the basis of the region designated by the creator 6, the setting section 14 sets the content region 3 with which content data is associated.

The set content region 3 and map information are stored in the storage 15 in association with each other.

The display controller 16 causes the content region 3 to be superimposed on map information to be displayed.

FIG. 3 schematically illustrates an example of a region setting graphical user interface (GUI).

For example, through a region setting GUI 18 as illustrated in FIG. 3, a region is designated by the creator 6, the content region 3 is set by the setting section 14, and the content region 3 is superimposed on map information to be displayed by the display controller 16.

As illustrated in FIG. 3, the region setting GUI 18 includes a map display section 19 that displays thereon map information, a region setting button 20 that is selected when the content region 3 is set, an OK button 21, a deletion button 22, a scale display section 23 that displays thereon a scale of map information, and a pair of plus and minus buttons 24 that is used to change a scale.

Map information displayed on the display section 19 can be changed discretionarily. Further, the content region 3 can be input by specifying a desired region in map information.

For example, the creator 6 displays desired map information, and operates the pair of plus and minus buttons 24 to adjust a scale. The creator 6 draws a region of a specified shape by operating, for example, a touch pen or a mouse. This results in a region being designated by the creator 6.

The creator 6 selects the OK button 21 in order to finally determine the designated region as the content region 3. The creator 6 selects the deletion button 22 in order to delete the drawn region.

The setting section 14 sets, to be position information regarding the content region 3, position information (a pair of latitude information and longitude information) regarding a region drawn by the creator 6.

Position information (a pair of latitude information and longitude information) regarding the set content region 3 is stored in the storage 15 in association with map information (a pair of latitude information and longitude information).

The content region 3 is superimposed on map information to be displayed on the map display section 19 by the display controller 16.

As described above, the content region 3 is superimposed on map information to be displayed, and this makes it easy to create a sound content map. Note that the region setting GUI 18 corresponds to an embodiment of image information that includes map information and is used to set a content region.

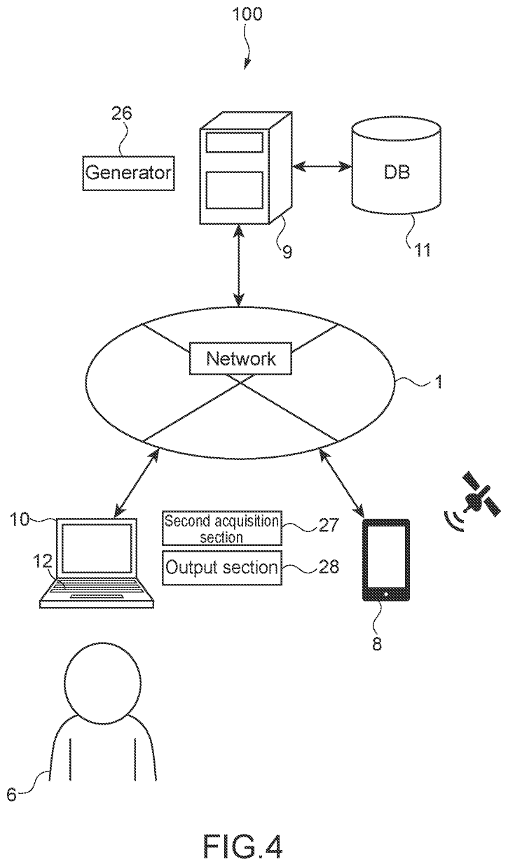

FIG. 4 schematically illustrates an example of the configuration of the content creation system according to another embodiment. The content creation system 100 illustrated in FIG. 4 further includes additional functional blocks for the server apparatus 9 and the information processing apparatus 10.

The content creation system 100 illustrated in FIG. 4 makes it possible to sufficiently suppress an impact that an error (a GPS error) in position information has on creation of a sound content map.

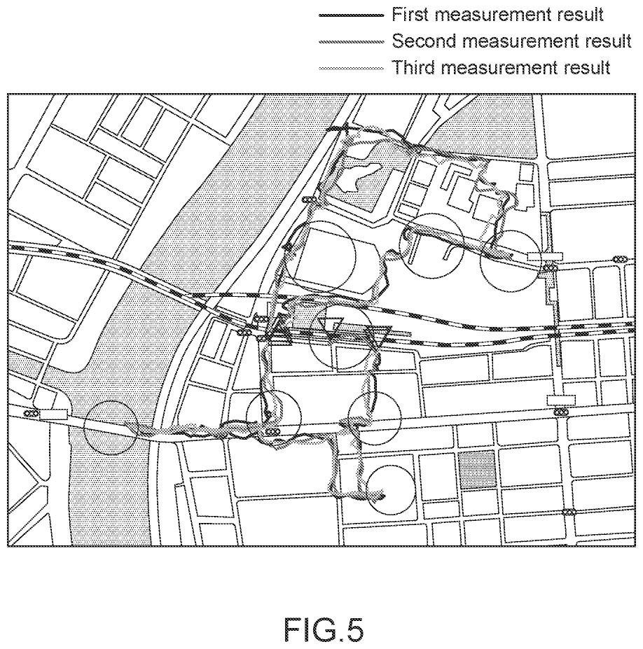

FIG. 5 is a schematic diagram used to describe a GPS accuracy.

FIG. 5 illustrates a trajectory of pieces of position information measured by the GPS when the content experient 2 moves along the same route while holding the mobile terminal 4 including a GPS sensor.

As illustrated in FIG. 5, an error may occur due to a difference between position information acquired using the GPS sensor and information regarding a position at which the content experient 2 is actually standing. Depending on, for example, the surrounding environment, an error in a range of from a few meters to a few hundred meters may occur.

When a sound content map is created, it is desirable that the entrance into and the exit from the content region 3 be detected with a high degree of accuracy and the playback of sound be controlled. On the other hand, the low degree of GPS accuracy results in a reduction in the accuracy in detecting the entrance into and the exit from the content region 3.

For example, even if a large landmark is set to be the content region 3, there is a possibility that, depending on the GPS accuracy, the entrance into the landmark will not be detected or, conversely, the entrance into the landmark will be erroneously detected in spite of being situated away from the landmark.

Further, the GPS accuracy will be more likely to have a great impact when there is a plurality of closely situated content regions 3.

When the entrance into the content region 3 is not detected, this will result in, for example, sound (such as background music, narration, or a line) not being played back.

When the entrance into an adjacent different content region 3 is erroneously detected, for example, sounds (such as narrations of different content regions 3) that are not supposed to be heard at the same time are heard at the same time. Alternatively, sound that is supposed to be played back may be overwritten, and unexpected sound may be played back (for example, narration that is supposed to be played back in a content region A is heard in a content region B).

It is conceivable that, for example, a huge amount of field evaluations could be carried out in the real world after the content region 3 is set, in order to deal with such an issue. In this case, there is a need for immense amounts of time and labor, and this may result in disturbing creation of a sound content map.

In the present embodiment, the server apparatus 9 further includes a generator 26 as a functional block, as illustrated in FIG. 4.

The generator 26 is implemented as a software block by, for example, a processor executing a specified program. Of course, dedicated hardware such as an integrated circuit (IC) may be used in order to implement the generator 26.

The generator 26 generates accuracy information regarding the accuracy of position information acquired by a position sensor. In the present embodiment, the accuracy information regarding the accuracy of position information (a pair of latitude information and longitude information) acquired by a GPS sensor is generated.

For example, position information (referred to as first position information) that is set by the creator 6 on the basis of map information is transmitted to the server apparatus 9. The creator 6 holding the mobile terminal 8 actually moves to a position, in the real world, that corresponds to the set first position information. Then, position information (referred to as second position information) acquired by a GPS sensor of the mobile terminal 8 is transmitted to the server apparatus 9.

The generator 26 generates the accuracy information on the basis of a difference between the first position information set on the basis of map information, and the second position information acquired by the GPS sensor at a position, in the real world, that corresponds to the first position information.

The difference between the first position information and the second position information corresponds to a GPS accuracy. The GPS accuracy is also information included in the accuracy information. In other words, the calculating a difference between the first position information and the second position information is also included in calculating the accuracy information on the basis of the difference between the first position information and the second position information.

Moreover, any information regarding the accuracy (the GPS accuracy) of position information may be generated as the accuracy information. For example, a correction value or the like that is used to correct the second position information may be generated as the accuracy information. Further, another method may be used as a method for generating the accuracy information.

In the example illustrated in FIG. 4, first position information, second position information, accuracy information, support information, and the like are stored in the DB 11, in addition to map information and information regarding the content region 3. Further, various information created in the past, history information, and the like may be stored.

The information processing apparatus 10 further includes a second acquisition section 27 and an output section 28 as functional blocks.

The second acquisition section 27 and the output section 28 are implemented as software blocks by, for example, a processor executing a specified program. Of course, dedicated hardware such as an integrated circuit (IC) may be used in order to implement each block.

The second acquisition section 27 acquires accuracy information regarding the accuracy of position information acquired by a position sensor. In the present embodiment, the accuracy information generated by the server apparatus 9 is acquired through the network 1.

On the basis of the acquired accuracy information, the output section 28 outputs support information regarding settings of the content region 3 associated with content data.

The support information includes any information that can support an operation of setting the content region 3 that is performed by the creator 6.

For example, the support information includes any information, such as any image information such as a GUI, an icon, and a guide; and any sound information such as guide sound, that can support the setting of the content region 3.

Further, the outputting support information includes any method for outputting data, such as displaying an image such as a GUI; and outputting sound such as guide sound, that can present support information to the creator 6.

Of course, the outputting support information also includes outputting image information (support information) in order for a display device to display the image information (the support information). Further, the outputting support information also includes outputting sound information (support information) to, for example, a speaker in order for, for example, the speaker to output the support information.

Also in the present embodiment, the region setting GUI 18 being used to set the content region 3 and including map information is displayed on the display section of the information processing apparatus 10.

Further, various information such as alert information, a correction region, a margin region, and information regarding content data is displayed on the region setting GUI 18.

The displaying the region setting GUI 18, and the displaying various support information on the region setting GUI 18 are also embodiments of the outputting support information according to the present technology. Thus, the display controller 16 illustrated in FIG. 1 may serve as the output section 28. Conversely, the output section 28 illustrated in FIG. 4 may serve as the display controller 16 illustrated in FIG. 1.

Any method such as displaying a region having a high degree of GPS accuracy, displaying a region having a low degree of GPS accuracy, displaying a landmark, displaying a point of interest (POI), and outputting error sound may be adopted as the outputting support information.

Further, accuracy information acquired by the second acquisition section 27 may be output as support information with no change. For example, a pair of the first position information and second position information described above as examples of generated accuracy information may be displayed as support information.

In other words, a pair of first position information that is set on the basis of map information, and second position information that is acquired by a GPS sensor (a position sensor) at a position, in the real world, that corresponds to the first position information may be displayed on the region setting GUI.

This enables the creator 6 to obtain information such as a region having a high degree of accuracy, a region having a low degree of accuracy, and a region in which there is a sudden decrease in GPS accuracy. This makes it possible to facilitate an operation of setting the content region 3. This results in being able to set the content region 3 in which the entrance or the exit of the content experient 2 can be detected with a high degree of accuracy.

An embodiment of the content creation system 100 illustrated in FIG. 4 is described in detail.

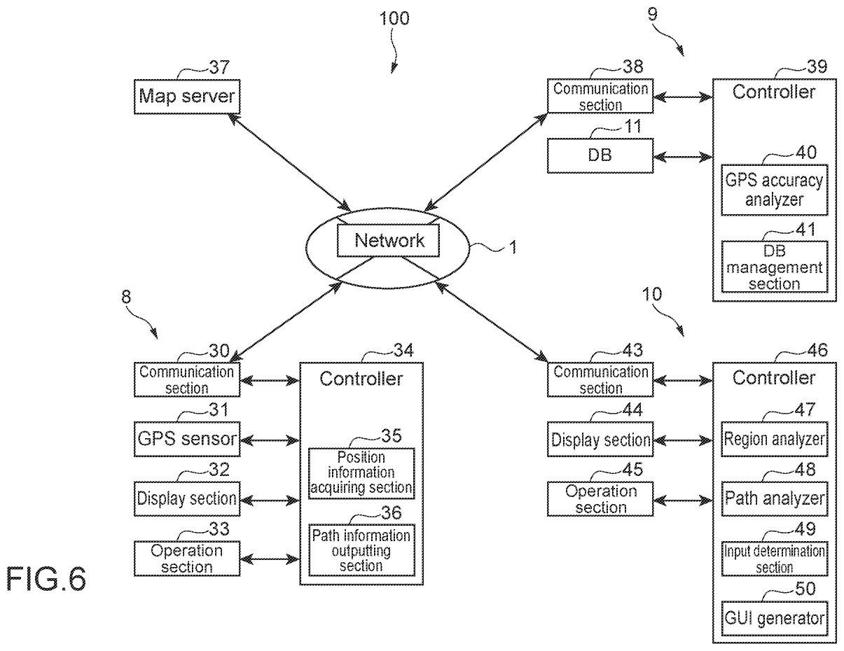

FIG. 6 is a block diagram illustrating an example of a functional configuration of the content creation system 100.

As illustrated in FIG. 6, the mobile terminal 8 includes a communication section 30, a GPS sensor 31, a display section 32, an operation section 33, and a controller 34.

The communication section 30 is a device used to communicate with another apparatus. For example, a wireless LAN module such as a Wi-Fi module, and a communication apparatus such as a modem and a router are used as the communication section 30. Any other communication device may be used.

The display section 32 displays various information such as map information and a GUI. Any display device such as a liquid crystal display or an organic electroluminescence (EL) display may be used as the advertisement display section 32.

Examples of the operation section 33 include a keyboard, a pointing device, a touch panel, and other operation apparatuses. When the operation section 33 includes a touch panel, the touch panel may be integrated with the display section 32.

The controller 34 includes hardware, such as a processor such as a CPU; a memory such as a ROM and a RAM; and a storage device such as an HDD, that is necessary for a configuration of a computer.

In the present embodiment, a position information acquiring section 35 and a path information outputting section 36 are implemented as functional blocks by the processor executing the program according to the present technology. Of course, dedicated hardware such as an integrated circuit (IC) may be used in order to implement the functional blocks.

In the present embodiment, a GPS measurement application is installed as a program according to the present technology. Further, the position information acquiring section 35 and the path information outputting section 36 perform processing for GPS measurement.

The server apparatus 9 includes a communication section 38, the DB 11, and a controller 39.

The controller 39 includes hardware, such as a processor such as a CPU; a memory such as a ROM and a RAM; and a storage device such as an HDD, that is necessary for a configuration of a computer.

In the present embodiment, a GPS accuracy analyzer 40 and a DB management section 41 are implemented as functional blocks by the processor executing the program according to the present technology.

The DB management section 41 manages information stored in the DB 11. Further, the DB management section 41 writes data into the DB 11 and reads data from the DB 11.

In the present embodiment, the generator 26 illustrated in FIG. 4 is implemented by the GPS accuracy analyzer 40. In other words, accuracy information is generated by the GPS accuracy analyzer 40.

The server apparatus 9 can also be referred to as a sound content map server.

The information processing apparatus 10 includes a communication section 43, a display section 44, an operation section 45, and a controller 46.

The controller 46 includes hardware, such as a processor such as a CPU; a memory such as a ROM and a RAM; and a storage device such as an HDD, that is necessary for a configuration of a computer.

In the present embodiment, a region analyzer 47, a path analyzer 48, an input determination section 49, and a GUI generator 50 are implemented as functional blocks by the processor executing the program according to the present technology.

The GUI generator 50 generates various GUIs used to create a sound content map, and causes the various GUIs to be displayed on the display section 44.

In the present embodiment, a region setting GUI used to set the content region 3, and a path setting GUI used to set an accuracy measurement path (hereinafter simply referred to as a measurement path) are generated to be displayed.

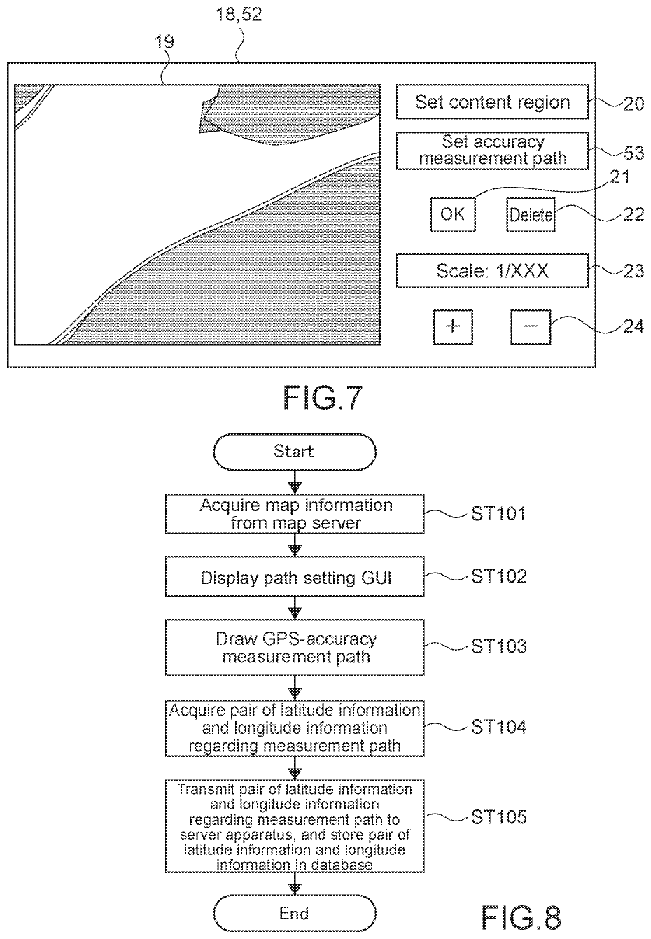

FIG. 7 schematically illustrates examples of a region setting GUI and a path setting GUI. In FIG. 7, the region setting GUI 18 and a path setting GUI 52 are formed into a single GUI.

The region setting GUI 18 includes the map display section 19 displaying thereon map information, the region setting button 20 selected when the content region 3 is set, the OK button 21, the deletion button 22, the scale display section 23 displaying thereon a scale of map information, and the pair of plus and minus buttons 24 used to change a scale.

Map information displayed on the display section 19 can be changed discretionarily. Further, the content region 3 can be input by specifying a desired region in map information.

For example, the creator 6 displays desired map information, and operates the pair of plus and minus buttons 24 to adjust a scale. The creator 6 draws a region of a specified shape by operating, for example, a touch pen or a mouse. This results in a region being designated by the creator 6.

The creator 6 selects the OK button 21 in order to finally determine the designated region as the content region 3. The creator 6 selects the deletion button 22 in order to delete the drawn region.

The path setting GUI 52 includes the map display section 19, a measurement path setting button 53 that is selected when a measurement path is set, the OK button 21, the deletion button 22, the scale display section 23, and the pair of plus and minus buttons 24.

In other words, the map display section 19, the OK button 21, the deletion button 22, the scale display section 23, and the pair of plus and minus buttons 24 are used by the region setting GUI 18 and the path setting GUI 52 as shared elements.

For example, the creator 6 displays desired map information, and operates the pair of plus and minus buttons 24 to adjust a scale. The creator 6 draws a line at a specified position by operating, for example, a touch pen or a mouse. The creator 6 selects the OK button 21 in order to set the line to be a measurement path. The creator 6 selects the deletion button 22 in order to delete the drawn line.

Configurations of the region setting GUI 18 and the path setting GUI 52 are not limited, and the region setting GUI 18 and the path setting GUI 52 may be designed discretionarily. In other words, the region setting GUI 18, the path setting GUI 52, types of the various buttons, the numbers of the various buttons, shapes of the various buttons are not limited to this example. The path setting GUI 52 corresponds to an embodiment of image information that includes map information and is used to set path information.

Note that the measurement path can also be referred to as a measurement route.

Moreover, the GUI generator 50 can also generate various GUIs, and causes the various GUIs to be displayed. Further, the GUI generator 50 draws a region and a line on the GUI in response to an operation being performed by the creator 6. Furthermore, the GUI generator 50 can also cause, for example, alert information to be displayed on the GUI.

For example, functional blocks such as a region drawing section, a path drawing section, and an information display section may be built up in the GUI generator 50.

The input determination section 49 determines information input by the creator 6 through the operation section 45. For example, the input determination section 49 determines an input instruction in response to an operation being performed on, for example, a touch panel, and determines, for example, coordinate information designated according to a drawing operation. Then, the input determination section 49 outputs the determination to a corresponding block.

For example, in response to an operation of selecting each button illustrated in FIG. 7, the input determination section 49 generates corresponding operation information, and outputs the generated operation information to, for example, the GUI generator 50. Further, indicated coordinate information is acquired in response to an operation of drawing a region or a line being performed on map information, and the acquired coordinate information is output to, for example, the GUI generator 50.

The GUI generator 50 draws a region and a line according to a drawing operation performed by the creator 6, on the basis of the coordinate information determined by the input determination section 49.

The region analyzer 47 analyzes the content region 3 input by the creator 6. Further, the region analyzer 47 acquires accuracy information that is generated by the server apparatus 9, and generates a correction region and a margin region as support information.

The path analyzer 48 analyzes a measurement path that is input by the creator 6.

In the present embodiment, the first acquisition section 13, the setting section 14, and the display controller 16 illustrated in FIG. 1 are implemented by the region analyzer 47, the path analyzer 48, the input determination section 49, and the GUI generator 50. Further, the second acquisition section 27 and the output section 28 illustrated in FIG. 4 are implemented by the region analyzer 47, the path analyzer 48, the input determination section 49, and the GUI generator 50.

In the present embodiment, the mobile terminal 8, the server apparatus 9, and the information processing apparatus 10 are communicatively connected to a map server 37 through the network 1, as illustrated in FIG. 6.

The map server 37 can output pieces of map information regarding various areas. Further, a pair of latitude information and longitude information is associated with map information as position information regarding each point.

The mobile terminal 8, the server apparatus 9, and the information processing apparatus 10 can each acquire map information from the map server 37 to cause the acquired map information to be displayed on a corresponding display section. Further, the mobile terminal 8, the server apparatus 9, and the information processing apparatus 10 can each acquire position information (a pair of latitude information and longitude information) regarding a point designated in map information by, for example, a creator.

A panoramic image obtained by panoramic image-capturing being performed at each point in the real world may be displayed as map information. For example, a panoramic image or the like that is captured from the Hyakutan dori Street may be displayed as map information. Further, an aerophoto may be displayed as map information.

For example, software used to use map information may be downloaded from, for example, the map server 37, and this may result in being able to, for example, display the map information, change a scale, and acquire position information regarding each point according to the scale. Alternatively, when an API used to use map information is published, the map information may become usable by calling the API.

[Setting of Measurement Path]

FIG. 8 is a flowchart illustrating an example of setting a measurement path.

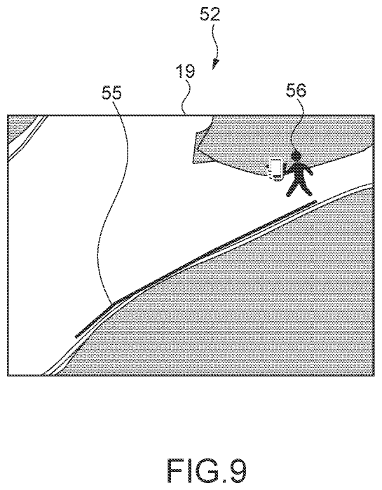

FIG. 9 illustrates an example of the path setting GUI 52 displayed when the measurement path is set. Note that FIG. 9 only illustrates the map display section 19 of the path setting GUI 52.

The information processing apparatus 10 acquires map information from the map server 37 (Step 101).

The GUI generator 50 causes the path setting GUI 52 to be displayed (Step 102).

For example, the creator 6 selects the measurement path setting button 53 to input an operation of drawing a line into a map displayed on the map display section 19.

The input determination section 49 and the GUI generator 50 cause a measurement path 55 to be superimposed on the map information to be displayed according to the line drawing operation input by the creator 6 (Step 103).

The path analyzer 48 acquires a pair of latitude information and longitude information regarding each point in the measurement path 55 (Step 104).

The information processing apparatus 10 transmits the pair of latitude information and longitude information regarding the measurement path 55 to the server apparatus 9. Then, the DB management section 41 of the server apparatus 9 registers, in the DB 11, the pair of latitude information and longitude information regarding the measurement path 55 (Step 105).

In the present embodiment, the pair of latitude information and longitude information regarding the measurement path 55 is included in first position information that is set on the basis of map information. Further, the pair of latitude information and longitude information regarding the measurement path 55 corresponds to path information that is set on the basis of map information.

In the example illustrated in FIG. 9, an icon 56 is displayed that makes it possible to see that the measurement path 55 is a path for which it is necessary to actually go to the spot to perform GPS measurement. As described above, information that supports to perform setting may be output for the measurement path 55.

For example, the presence of a guide makes it more useful in precisely walking along the measurement path 55 upon actually walking along the measurement path 55. Thus, a drawing operation may be guided such that the measurement path 55 can be drawn along, for example, a white line or a guard rail on a road.

Alternatively, a road, a start point, and an end point are designated by the creator 6, and the measurement path 55 may be set to be drawn according to the designation of the road, the start point, and the end point, in order to make it possible to actually walk easily.

The GUI generator 50 may output information regarding a scale of map information.

For example, there is a difference between a small scale (a large scale denominator) and a large scale (a small scale denominator) in a width, in the real world, that corresponds to a width of the measurement path 55 illustrated in FIG. 9.

For example, if the scale is too large, a width of a path, in the real world, that corresponds to the measurement path 55 will be very large. This results in there being a need to walk a large area that corresponds to the path, in the real world, that corresponds to the measurement path 55.

Consequently, there is a possibility that a result of measuring a GPS accuracy obtained by comparing position information acquired by the GPS sensor 31 during walking with position information regarding the measurement path 55 set through the path setting GUI 52, will not be precise.

Thus, a range of a scale that is permitted to be set may be determined when the measurement path 55 is set. For example, when the scale is greater than a specified threshold, alert information that indicates this matter may be displayed without a measurement path being permitted to be input. For example, presentation to a creator may be performed by, for example, displaying a text such as “The scale is too large. Set the scale to 1/XXX or less”, or using sound.

Of course, information indicating “Set the scale to 1/XXX or less” may be output at the beginning, in response to the measurement path setting button 53 being selected.

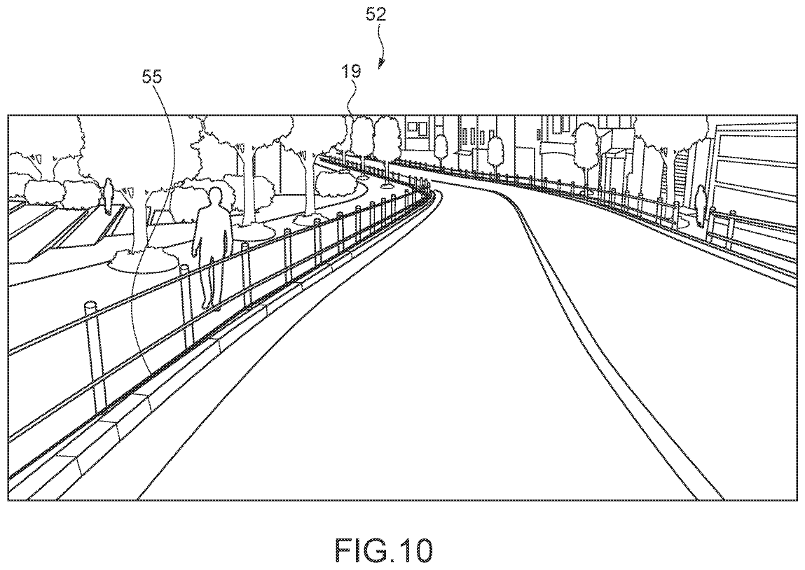

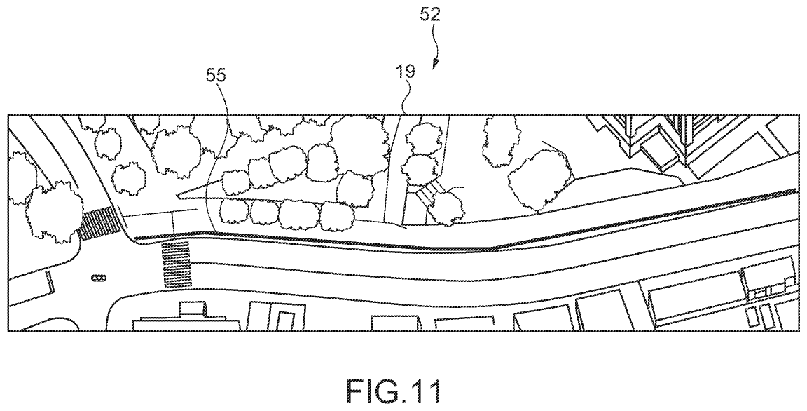

FIGS. 10 and 11 are schematic diagrams used to describe other examples of setting a measurement path.

In the example illustrated in FIG. 10, a panoramic image obtained by panoramic image-capturing being performed in the real world is displayed as map information.

For example, the creator 6 can set the measurement path 55 at a boundary of a road and a left sidewalk by operating the operation section 45.

Further, as illustrated in FIG. 11, an aerophoto may be displayed as map information. The aerophoto makes it possible to accurately set the measurement path 55 along a sidewalk.

[GPS Measurement]

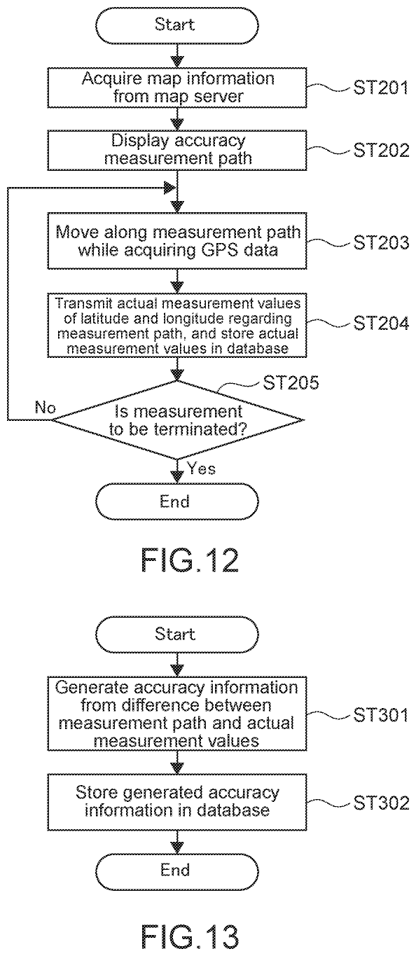

FIG. 12 is a flowchart illustrating an example of GPS measurement.

The creator 6 holding the mobile terminal 8 moves to a point in a path, in the real world, that corresponds to the measurement path 55 (hereinafter referred to as a corresponding measurement path).

Then, the creator 6 starts a GPS measurement application according to the present technology.

The mobile terminal 8 acquires map information from the map server 37 (Step 201).

The path information outputting section 36 acquires, from the server apparatus 9, position information (a pair of latitude information and longitude information) regarding the measurement path 55 set through the path setting GUI 52. Then, the measurement path 55 is superimposed on the map information to be displayed.

For example, the map information including the measurement path 55, as illustrated in FIG. 9, is displayed. Note that the icon 56 may only be displayed upon GPS measurement without being displayed when the measurement path 55 is set.

Further, the panoramic image including the measurement path 55, as illustrated in FIG. 10, and the aerophoto including the measurement path 55, as illustrated in FIG. 11, may be displayed.

For example, a scale may be unconditionally settable when the measurement path 55 is set. In other words, the measurement path 55 is input with a very large scale. The path analyzer 48 acquires a pair of latitude information and longitude information regarding the measurement path 55 in response to the input, and transmits the acquired pair of latitude information and longitude information to the server apparatus 9.

Upon GPS measurement, the creator 6 optimizes a scale for map information including the measurement path 55 displayed on the display section 32 of the mobile terminal 8. For example, when, for example, the aerophoto as illustrated in FIG. 11 is used, the optimization of a scale makes it possible to precisely grasp a path to walk.

Of course, a range of a settable scale may be determined when the measurement path 55 is set, and a scale of map information including the measurement path 55 may be optimized by the creator 6 upon GPS measurement.

The position information acquiring section 35 acquires position information obtained by sensing performed on the corresponding measurement path. In the present embodiment, the GPS sensor 31 acquires the position information (a pair of latitude information and longitude information) during walking the corresponding measurement path (Step 203).

For example, displaying, for example, a GUI results in encouraging the creator 6 to input, for example, a start button, the input of the start button corresponding to a trigger for starting GPS measurement at a start point of a corresponding measurement path. Further, the displaying, for example, a GUI results in encouraging the creator 6 to input, for example, a termination button, the input of the termination button corresponding to a trigger for terminating the GPS measurement at an end point of the corresponding measurement path.

In response to the start button being input, the position information acquiring section 35 acquires, as a result of actual measurement, position information acquired by the GPS sensor 31. The acquired position information is transmitted to the server apparatus 9, and is registered in the DB 11 by the DB management section 41 as a result of actual measurement performed by the measurement path 55 (Step 204).

The processes of Steps 203 and 204 are repeated until the termination button is input. When the termination button is input, it is determined that the measurement is to be terminated, and the processing is terminated (Step 205).

In the present embodiment, the position information acquiring section 35 acquires, as an actual measurement result, pieces of position information acquired by a GPS sensor from a start button being input to a termination button being input, as described above. Of course, the embodiments are not limited to such a method.

[Generation of Accuracy Information]

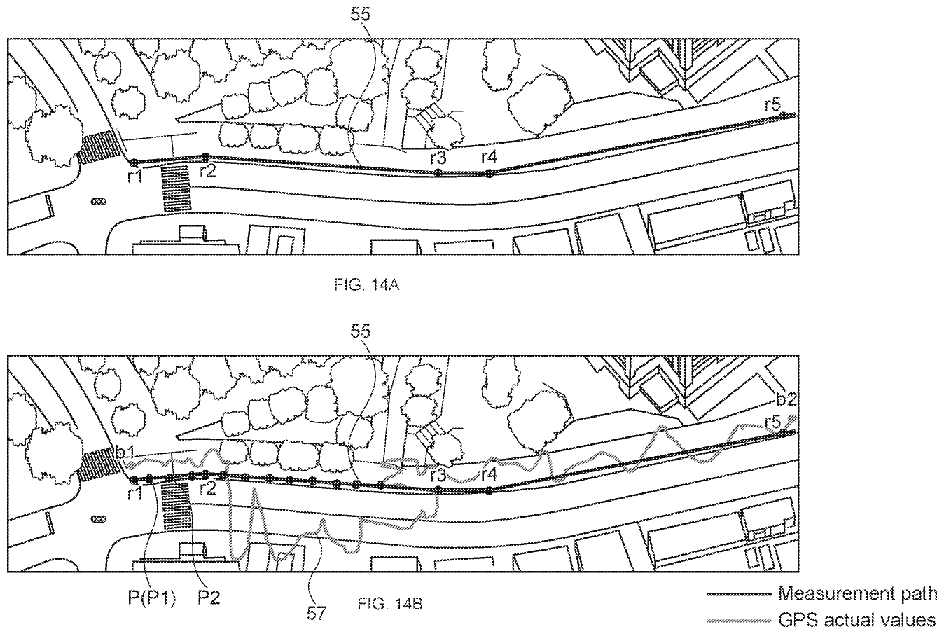

FIG. 13 is a flowchart illustrating an example of generating accuracy information.

The GPS accuracy analyzer 40 of the server apparatus 9 generates accuracy information from a difference between position information regarding the measurement path 55 and actually measured values (position information) actually measured in a corresponding measurement path. In other words, accuracy information is generated on the basis of a difference between path information set on the basis of map information, and position information acquired by the GPS sensor 31 in a path, in the real world, that corresponds to the path information (Step 301).

For example, with respect to a measurement path based on map information, a pair of latitude information and longitude information is associated at each point.

As actually measured values acquired by the GPS sensor 31, a pair of latitude information and longitude information is acquired at a specified frame rate during walking along the corresponding measurement path. For example, a set of a measurement time and position information (a pair of latitude information and longitude information) is acquired every second.

Note that the set of a measurement time and position information (a pair of latitude information and longitude information) is also acquired when a start button is input and when a termination button is input. Of course, an actually measured value first acquired after input of a termination button may be used as an actually measured value upon termination of measurement.

For example, the GPS accuracy analyzer 40 can associate position information regarding the measurement path 55 with a set of a time of starting measurement, a time of terminating the measurement, and actually measured values acquired every second from the time of starting measurement to the time of terminating the measurement, and the GPS accuracy analyzer 40 can generate a difference between the position information and the set as accuracy information.

For example, position information regarding the measurement path 55 at a start point and an actually measured value acquired upon starting measurement are associated with each other. Further, position information regarding the measurement path 55 at an end point and an actually measured value acquired upon terminating measurement are associated with each other.

The measurement path 55 is divided (for example, is equally divided) by division points of which the number is the same as the number of actually measured values acquired every second from a time of starting measurement to a time of terminating the measurement. Then, actually measured values of a plurality of actually measured values are respectively associated with division points of a plurality of division points in turn from a point of starting measurement. A difference between an actually measured value and position information at a corresponding division point is generated as accuracy information.

FIG. 14 is a schematic diagram used to describe another example of associating a measurement path with actually measured values.

First, a total distance of the measurement path 55 set by the creator 6 is calculated.

For example, it is assumed that a plurality of control points r1 to r5 is designated by the creator 6, and the measurement path 55 is set by connecting the plurality of control points r1 to r5, as illustrated in A of FIG. 14. The control point r1 is a start point of the measurement path 55, and the control point r5 is an end point of the measurement path 55.

The GPS accuracy analyzer 40 acquires position information (a pair of latitude information and longitude information) regarding each of the control points r1 to r5. A distance between the control points r1 and r2, a distance between the control points r2 and r3, a distance between the control points r3 and r4, and a distance between the control points r4 and r5 are each calculated using the Hybeny's formula. The calculated distances are added to calculate the total distance between the control points r1 to r5. The total distance corresponds to a total movement distance that the creator 6 moves upon actual measurement.

Moreover, any method may be used as a method for calculating the total distance of the measurement path 55.

B of FIG. 14 illustrates a result 57 of GPS actual measurement. The result 57 of GPS actual measurement corresponds to a line obtained by connecting chronologically arranged actual measurement values from an actual measurement value b1 upon starting measurement to an actual measurement value b2 upon terminating the measurement, the actual measurement value being acquired every second.

Actual measurement is performed upon starting measurement at a position, in the measurement path 55, that corresponds to the control point r1, and this results in obtaining the actual measurement value b1. Further, actual measurement is performed upon terminating measurement at a position, in the measurement path 55, that corresponds to the control point r5, and this results in obtaining the actual measurement value b2.

On the basis of the total movement distance between the control points r1 and r5 and a measurement time (a measurement time for the actual measurement value b2−a measurement time for the actual measurement value b1), the GPS accuracy analyzer 40 calculates an average movement speed (the total movement distance/the measurement time).

A position P in the measurement path 55 for each second upon moving along the measurement path 55 at the average movement speed from the control point r1 to the control point r5, is calculated.

For example, it is assumed that the distance between the control points r1 and r2 is 150 m, and the average movement speed is 50 m/minute. In this case, a creator moves ⅚ m every second along a straight line (of a length of 150 m) from the control point r1 to the control point r2.

It is assumed that a position (coordinates) of the control point r1 in the aerophoto illustrated in B of FIG. 14 is r1, and a position (coordinates) of the control point r2 in the aerophoto is r2. In this case, in the aerophoto illustrated in B of FIG. 14, the creator having started at the control point r1 is situated at a position P1 after a second, the position P1 being calculated by (r2−r1)×(⅚)×( 1/150). The creator is situated at a position P2 after two seconds, the position P2 being calculated by 2×(r2−r1)×(⅚)×( 1/150).

An actually measured value (the first actually measured value) actually measured a second after measurement is started is acquired at the position P1 of the creator after a second. An actually measured value (the second actually measured value) actually measured two seconds after measurement is started is acquired at the position P2 of the creator after two seconds.

The same calculation is repeated for the control points r1 to r5, and this makes it possible to calculate the position P of the creator 6 in the measurement path 55 for each second. Position information (a pair of latitude information and longitude information) at each calculated position P can be acquired, and a difference between the position information and an actually measured value actually measured at the position P can be generated as accuracy information.

Moreover, any algorithm may be adopted to generate accuracy information based on a difference between the measurement path 55 and actually measured values.

Any method may be adopted if it is possible to grasp, in a sound content map, a degree of error due to a difference between a pair of latitude information and longitude information that is acquired by the mobile terminal 4 playing back content data, and a pair of actual longitude and latitude.

The generated accuracy information is stored in the DB 11 by the DB management section 41 of the server apparatus 9 (Step 302). In the following description, the accuracy information may be referred to as a GPS accuracy.

[Calculation of Correction Region (Margin Region)]

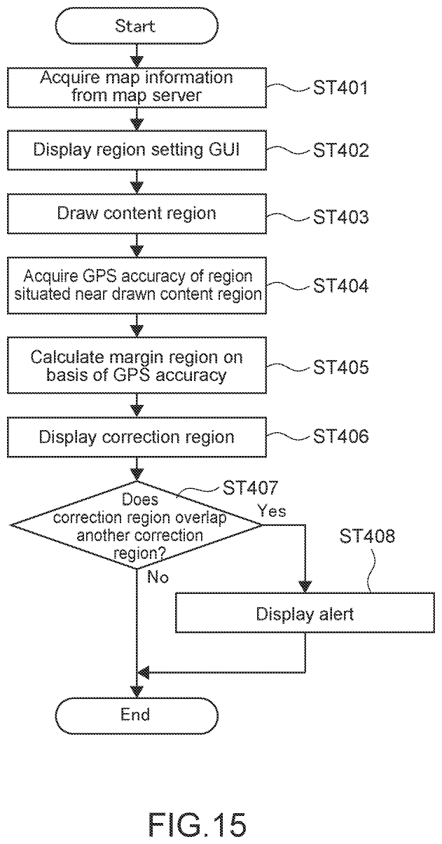

FIG. 15 is a flowchart illustrating an example of calculating a correction region (a margin region).

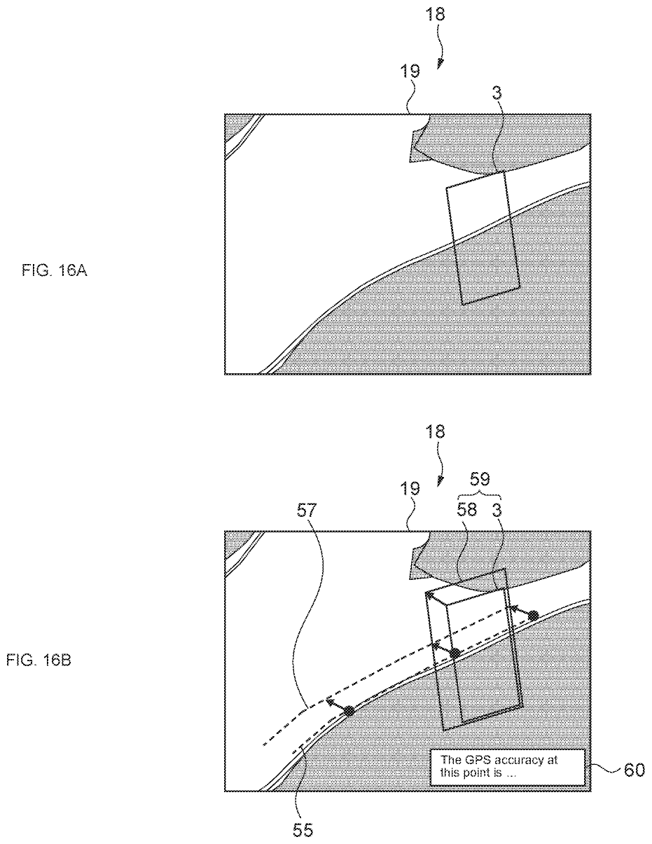

FIG. 16 illustrates an example of the region setting GUI 18 displayed when the content region 3 is set. Note that FIG. 16 only illustrates the map display section 19 of the region setting GUI.

The information processing apparatus 10 acquires map information from the map server 37 (Step 401).

The GUI generator 50 causes the region setting GUI 18 to be displayed (Step 402).

For example, the creator 6 selects the region setting button 20 to input an operation of drawing a region into a map displayed on the map display section 19.

As illustrated in A of FIG. 16, the input determination section 49 and the GUI generator 50 cause the content region 3 to be superimposed on the map information to be displayed according to the region drawing operation input by the creator 6 (Step 403).

The region analyzer 47 acquires, from the server apparatus 9, the GPS accuracy of (accuracy information regarding) a region situated near the drawn content region 3.

For example, the GPS accuracy generated on the basis of the measurement path 55 set to pass through the drawn content region 3 is acquired. Of course without being limited thereto, the GPS accuracy generated on the basis of the measurement path set in a region situated near the drawn content region 3.

Further, a set of the set measurement path 55 and actually measured values may be acquired together with the accuracy information. Note that the sets of the set measurement path 55 and actually measured values that are set in order to generate accuracy information are also information regarding GPS accuracy, and thus, are information included in the accuracy information.

The region analyzer 47 calculates a margin region 58 on the basis of the GPS accuracy.

As illustrated in B of FIG. 16, the margin region 58 is calculated using the drawn content region 3 input on the basis of map information on the region setting GUI 18 as a reference. The margin region 58 is a region that includes position information that may be acquired by the GPS sensor 31 at a position, in the real world, that corresponds to a position in the content region 3 input by the creator.

For example, in the example illustrated in B of FIG. 16, the entirety of the result 57 of GPS actual measurement is shifted to the upper left from the measurement path 55. With respect to the GPS accuracy (accuracy information), a difference between a position in the measurement path and a corresponding actually measured value is acquired as, for example, vector information. The GPS accuracy may be generated only using a difference between the measurement path 55 and actually measured values in a portion included in the content region 3.

Depending on the GPS accuracy, position information situated on the upper left as viewed from the content region 3 may be acquired by the GPS sensor 31 in the content region 3. Thus, the region analyzer 47 calculates the margin region 58 on a left side and an upper side of the content region 3 along a region situated on the left side and the upper side of the content region 3.

The margin region 58 may be added to the entirety of a peripheral edge of content region 3. In other words, the margin regions 58 may be added to regions situated on all of the left, right, upper, and lower sides of the rectangular content region 3. Alternatively, the margin region 58 may be added to only a portion of the peripheral edge of the content region 3. Further, the margin region 58 is not limited to being rectangular, and the margin regions 58 of different shapes may be added on all of the left, right, upper, and lower sides of the rectangular content region 3 when the margin regions 58 may be added to regions situated on the respective sides.

Note that the margin region 58 is not limited to being calculated such that all pieces of position information that may be acquired by the GPS sensor 31 at a position, in the real world, that corresponds to a position in the content region 3. A region that includes at least one actually measured value actually measured at a position in the content region 3 is included in the margin region 58 according to the present technology.

In the present embodiment, a region obtained by combining the margin region 58 and the input content region 3 is referred to as a correction region 59. The correction region 59 is a region used as a reference when the content region 3 is corrected. Note that the present technology can be applied, with the margin region 58 being an embodiment of a correction region according to the present technology.

As in the case of the margin region 58, the correction region 59 is a region that is calculated using the content region 3 input on the basis of map information in the region setting GUI 18 as a reference. Further, the correction region 59 is a region that includes position information that may be acquired by the GPS sensor 31 at a position, in the real world, that corresponds to a position in the content region 3 input by the creator 6.

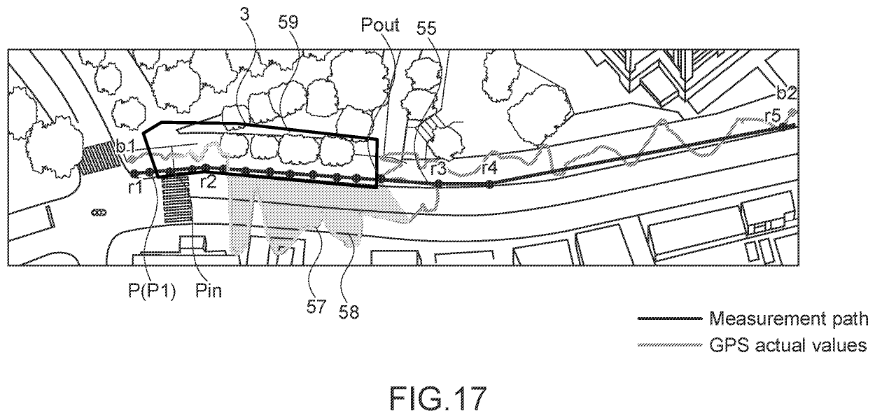

FIG. 17 is a schematic diagram used to describe another example of calculating the margin region 58.

It is assumed that an actually measured value acquired every second since start of measurement is associated with the position P (a position of a creator for each second) at the time of acquiring the actually measured value, as described with reference to B of FIG. 14.

It is assumed that the creator 6 inputs the content region 3 as illustrated in FIG. 17.

With respect to the position P of the creator for each second, the region analyzer 47 extracts a position Pin at which the creator enters the content region 3 from the outside of the content region 3, and a position Pout at which the creator exits the content region 3 to the outside of the content region 3. The extraction can be determined by comparing a pair of latitude information and longitude information regarding each position P with a pair of latitude information and longitude information regarding the content region 3.

The result 57 of actual measurement from an actually measured value at the position Pin at which the creator enters the region from the outside of the region to an actually measured value at the position Pout at which the creator exits the region to the outside of the region, is extracted. The extracted result 57 of actual measurement corresponds to actually measured values acquired during movement in the content region 3.

It is determined whether each actually measured value included in the result 57 of actual measurement is within or outside of the content region 3. A region situated between actually measured values determined to be outside of the content region 3 and the content region 3 is calculated as the margin region 58.

In the example illustrated in FIG. 17, a region displayed in gray corresponds to the margin region 58. A region obtained by combining the margin region 58 and the content region 3 corresponds to the correction region 59. The use of this generation example makes it possible to generate the margin region 58 (the correction region 59) having a high degree of accuracy.

The generated margin region 58 is superimposed on map information in the region setting GUI 18 to be displayed. In the present embodiment, the correction region 59 obtained by combining the margin region 58 and the content region 3 is displayed (Step 406). Of course without being limited thereto, only the margin region 58 may be displayed.

As illustrated in B of FIG. 16, information 60 regarding the GPS accuracy in a region situated near a portion into which the content region 3 is input by the creator 6 may be output on the basis of the GPS accuracy. For example, information such as “The GPS accuracy at this point is high.” or “The GPS accuracy at this point is low.” may be output.

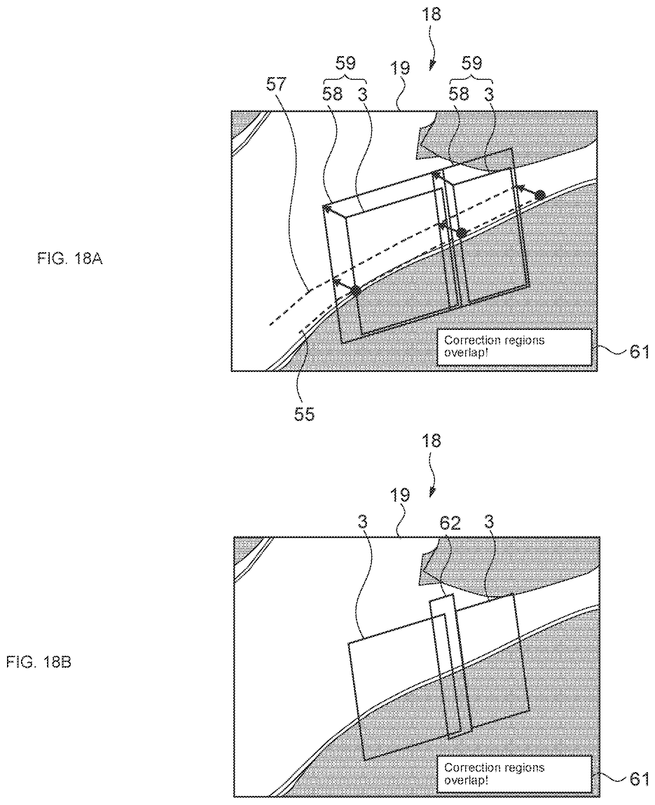

FIG. 18 is a schematic diagram used to describe an example in which a plurality of content regions 3 is input.

A plurality of content regions 3 may be input by the creator 6. In this case, the region analyzer 47 causes a plurality of correction regions 59 (a plurality of margin regions 58) based on the plurality of content regions 3 to be displayed on the region setting GUI 18, as illustrated in A of FIG. 18. In other words, the processes of Steps 403 to 406 are performed for each content region 3, and the correction regions 59 are displayed.

In the present embodiment, at least one correction region 59 based on at least one content region 3 input on the basis of map information on the region setting GUI 18 (in image information) is displayed on the map information, as described above.

In Step 407, the region analyzer 47 determines whether the correction region 59 overlaps another correction region 59.

For example, when the creator 6 closely arranges the content regions 3 at a point having a low degree of GPS accuracy, the region analyzer 47 determines whether the correction regions 59 calculated for the respective content regions 3 overlap. This determination corresponds to determining an overlap of the content regions 3 based on the GPS accuracy with respect to each content region 3.

For example, it is possible to intendedly cause the content regions 3 to overlap, and to cause the content experient to listen to different kinds of sound at the same time. On the other hand, an unintended overlap of the content regions 3 results in an erroneous recognition. Consequently, for example, different kinds of sound are unintendedly heard at the same time, and this causes a problem.

In the present embodiment, when the correction regions 59 overlap (Yes in Step 407), alert information 61 is output (Step 408), as illustrated in A of FIG. 18. For example, alert information such as “The correction regions overlap!”, “Input the content regions again since the correction regions overlap.”, “Drawn regions might be erroneously recognized since the regions are closely situated for the GPS accuracy of this point. Designate the regions in order for the regions to not overlap.” is displayed.

Of course without being limited thereto, any alert information may be output. Further, alert information may be output using sound.

As illustrated in B of FIG. 18, only overlapping regions 62 of the correction regions 59 (the margin regions 58) may be displayed when the overlap occurs.

Further, the overlapping regions 62 of a plurality of correction regions 59 may be highlighted to be displayed. The overlapping regions 62 may be highlighted in, for example, red. Alternatively, a mark or the like may be displayed. Note that the highlighting and displaying includes only displaying the overlapping regions 62, as illustrated in B of FIG. 18.

Note that the overlap of the correction regions 59 includes not only an overlap of the margin regions 58, but also an overlap of the margin region 58 and the content region 3.

When the correction regions 59 do not overlap, (No in Step 407), the processing is terminated.

If necessary, the creator 6 corrects the content region 3 with reference to the displayed correction region 59, and inputs the OK button 21. Accordingly, the content region 3 is set.

For example, the display correction region 59 may be set to be the content region 3 with no change. Alternatively, the content region 3 may be moved in the correction region 59. Moreover, any operations such as a change in position, a change in size, and a change in shape may be performed. Of course, modifications do not have to be performed.

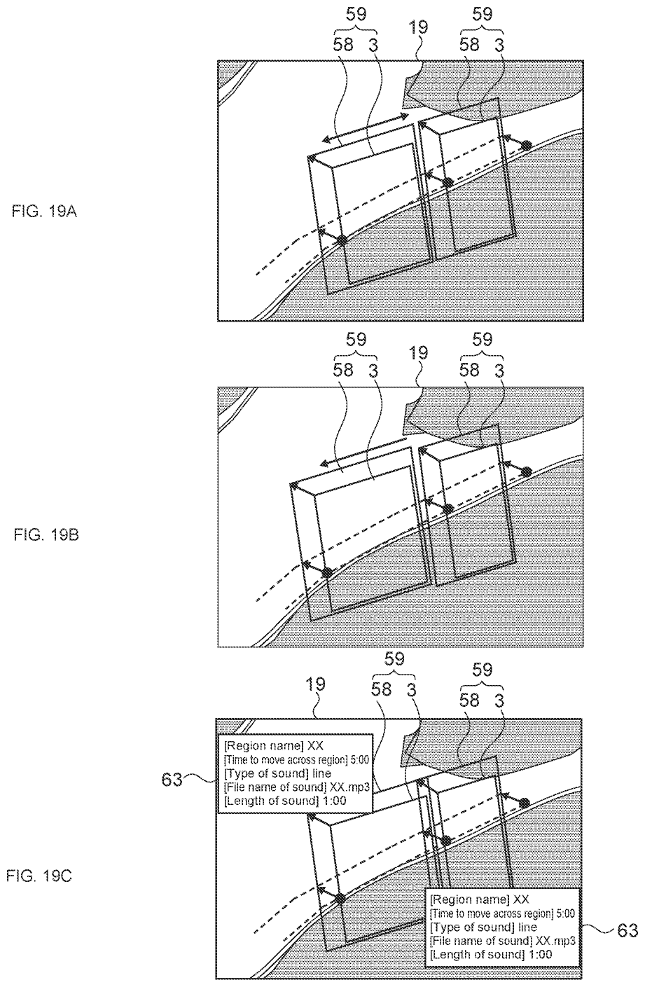

FIG. 19 is a schematic diagram used to describe processing that can be performed when the correction regions 59 overlap.

As illustrated in A of FIG. 19, a size of the correction region 59 may be automatically adjusted in order for the correction regions 59 to not overlap. The adjusting the size of the correction region 59 includes all of adjusting a size of the margin region 58, adjusting a size of the content region 3, which is original for the correction region 59, and adjusting the sizes of the margin region 58 and the content region 3.

As illustrated in B of FIG. 19, the correction region 59 may be automatically moved in order for the correction regions 59 to not overlap. In other words, a position of the correction region 59 may be automatically adjusted.

When the correction regions 59 of a plurality of correction regions 59 overlap, as illustrated in A and B of FIG. 19, positions, sizes, or shapes of the plurality of correction regions 59 may be changed discretionarily in order for the correction regions 59 to no longer overlap. In other words, the correction region 59 may be deformed as appropriate.

As illustrated in C of FIG. 19, information 63 regarding the overlapping correction regions 59 may be displayed.

For example, information regarding the input content region 3, and information regarding sound content data (sound) associated with the content region 3 are displayed.

In the example illustrated in C of FIG. 19, [Region name], [Time to move across region], [Type of sound], [File name of sound], and [Length of sound] are displayed. The information to be displayed is not limited to these pieces of information, and any information may be displayed.

Note that [Type of sound], [File name of sound], and [Length of sound] correspond to information regarding content data associated with the content region 3 corresponding to each of the plurality of correction regions 59.

When the processing illustrated in A to C of FIG. 19 is performed, this makes it possible to facilitate an operation of setting the content region 3. Further, this results in being able to set the content region 3 in which the entrance or the exit of the content experient 2 can be detected with a high degree of accuracy.

In the content creation system 100 according to the present embodiment, the content region 3 is set on the basis of designation of a region that is performed by the creator 6, as described above. Further, the set content region 3 is superimposed on map information to be displayed. This makes it possible to easily create content that uses position information.

Further, in the content creation system 100 according to the present embodiment, support information regarding setting of the content region 3 is output on the basis of accuracy information regarding the accuracy of position information acquired by the GPS sensor 31. This makes it possible to suppress an impact that an error in position information has on setting of the content region 3.

The application of the above-described present technology makes it possible to display the margin region 58 obtained by adding the GPS accuracy of a point to the content region 3 designated by the creator 6.

Further, when the creator 6 closely arranges the content regions 3 at a point having a low degree of GPS accuracy, an overlap of the content regions 3 based on the point can be determined. Furthermore, this makes it possible to encourage the creator 6 to move or change the content region 3. Alternatively, the overlap can be automatically adjusted.

This results in being able to create a sound content map having a high degree of accuracy while omitting a huge amount of field evaluations in the real world.

### Other Embodiments

The present technology is not limited to the embodiments described above, and can achieve various other embodiments.

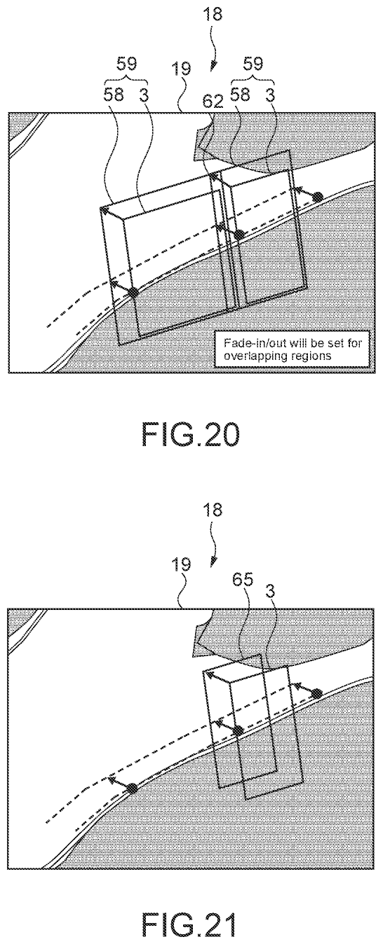

When the correction regions 59 overlap, setting can be performed such that each piece of sound content data is faded in/faded out in overlapping regions, as illustrated in FIG. 20.

For example, using the region setting GUI 18, the creator 6 can perform setting such that sound content data is played back by being faded in or out.

As illustrated in FIG. 21, the region analyzer 47 may deform, on the basis of GPS accuracy, the content region 3 input by the creator 6 to display an actually detected detection region 65. Note that the deforming the content region 3 includes, for example, changing a position, changing a size, and changing a shape.

This enables the creator 6 to view how the input content region 3 is actually detected.

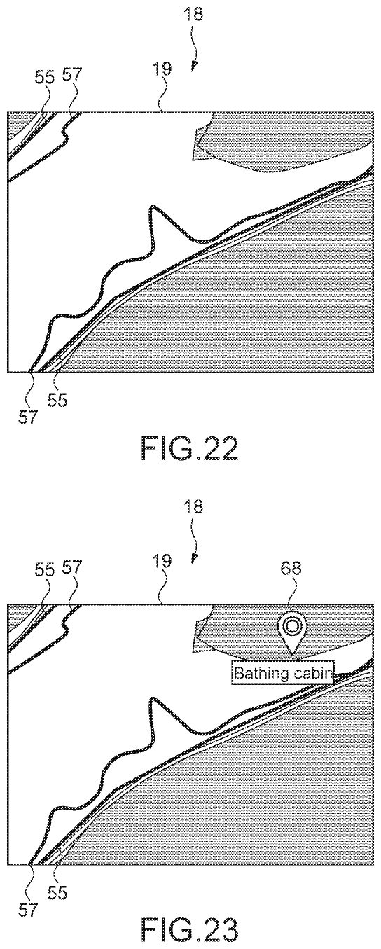

As illustrated in FIG. 22, a set of the measurement path 55 (path information) and the result 57 of actual measurement (hereinafter referred to as comparison-target information) may be displayed on the region setting GUI 18, the measurement path 55 being set on the basis of map information, the result 57 of actual measurement being acquired by the GPS sensor 31 in a path, in the real world, that corresponds to the measurement path 55. Further, the comparison-target information may be superimposed on map information on the region setting GUI 18.

This enables the creator 6 to view the GPS accuracy at each point. This makes it possible to guide the creator 6 to a point at which the input content region 3 can be accurately set.

As illustrated in FIG. 23, a POI 68 situated around the measurement path 55 may be acquired from the map server 37, and the POI 68 at which the difference between the measurement path 55 and the result 57 of actual measurement is small may be displayed on a map.

In other words, a POI situated around a point having a high degree of GPS accuracy may be acquired from the map server 37 to be displayed, where the point having a high degree of GPS accuracy is determined by acquiring the GPS accuracy for each point.

When the POI 68 having a high degree of GPS accuracy is displayed to the creator 6, this makes it possible to provide the creator 6 with information as a clue used when the creator 6 selects the input content region 3.

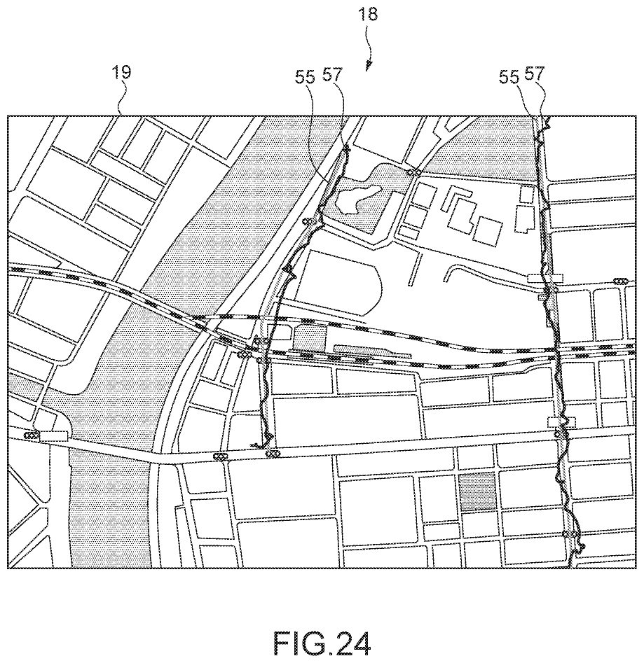

As illustrated in FIG. 24, a plurality of pieces of comparison-target information (a plurality of sets of measurement path 55 and the result 57 of actual measurement) may be merged on one map to be displayed together.

When one map with which a point having a high degree of GPS accuracy can be viewed, this makes it possible to provide the creator 6 with information as a clue used when the creator 6 selects the input content region 3.

For example, pieces of comparison-target information collected by a plurality of creators 6 are put together.

When the result 57 of actual measurement, which corresponds to the measurement path 55, is acquired, actual measurement may be performed multiple times, and, for example, a minimum value, an average, or a maximum value of a result of the actual measurement may be used.

Further, a trial use or the like of a sound content map may be made available, and accuracy information may be generated or updated using a result of actual measurement that is obtained when the sound content map is used by the content experient 2.

Sound data (sound content data) has been described above as an example of content data that is associated with the content region 3. Without being limited thereto, other content data such as image data may be associated with the content region 3.

For example, a portion of or all of the functions of the server apparatus 9 illustrated in FIG. 6 may be included in the information processing apparatus 10. Alternatively, the portable information processing apparatus 10 may be used, and a portion of or all of the functions of the mobile terminal 8 may be included in the portable information processing apparatus 10. For example, the information processing apparatus 10 may include the generator 26 illustrated in FIG. 4.

In other words, the content creation system 100 may be implemented by a plurality of computers or by a single computer.

FIG. 25 is a block diagram illustrating an example of a hardware configuration of a computer 70 by which each of the mobile terminal 8, the server apparatus 9, and the information processing apparatus 10 can be implemented.

The computer 70 includes a CPU 71, a ROM 72, a RAM 73, an input/output interface 75, and a bus 74 through which these components are connected to each other. A display section 76, an input section 77, a storage 78, a communication section 79, a drive 80, and the like are connected to the input/output interface 75.

The display section 76 is a display device using, for example, liquid crystal or EL. Examples of the input section 77 include a keyboard, a pointing device, a touch panel, and other operation apparatuses. When the input section 77 includes a touch panel, the touch panel may be integrated with the display section 76.

The storage 78 is a nonvolatile storage device, and examples of the storage 78 include an HDD, a flash memory, and other solid-state memories. The drive 80 is a device that can drive a removable recording medium 81 such as an optical recording medium or a magnetic recording tape.

The communication section 79 is a modem, a router, or another communication apparatus that can be connected to, for example, a LAN or a WAN and is used to communicate with another device. The communication section 79 may perform communication wirelessly or by wire. The communication section 79 is often used in a state of being separate from the computer 70.

Information processing performed by the computer 70 having the hardware configuration described above is performed by software stored in, for example, the storage 78 or the ROM 72, and hardware resources of the computer 70 working cooperatively. Specifically, the information processing method according to the present technology is performed by loading, into the RAM 73, a program included in the software and stored in the ROM 72 or the like and executing the program.

For example, the program is installed on the computer 70 through the recording medium 71. Alternatively, the program may be installed on the computer 70 through, for example, a global network. Moreover, any non-transitory computer-readable storage medium may be used.

The information processing method and the program according to the present technology may be executed and the information processing apparatus according to the present technology may be implemented by a plurality of computers communicatively connected to each other working cooperatively through, for example, a network.

In other words, the information processing method and the program according to the present technology can be executed not only in a computer system that includes a single computer, but also in a computer system in which a plurality of computers operates cooperatively.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both the case in which the acquisition of map information, the setting of a content region, the superimposition and display of content regions, the generation of accuracy information, the acquisition of accuracy information, the output of support information, and the like are executed by a single computer; and the case in which the respective processes are executed by different computers. Further, the execution of the respective processes by a specified computer includes causing another computer to execute a portion of or all of the processes and acquiring a result of it.

In other words, the information processing method and the program according to the present technology are also applicable to a configuration of cloud computing in which a single function is shared and cooperatively processed by a plurality of apparatuses through a network.

The respective configurations of the content creation system, the sound content map, the mobile terminal, the server apparatus, the information processing apparatus, and the various GUIs; the respective processing flows; and the like described with reference to the respective figures are merely embodiments, and any modifications may be made thereto without departing from the spirit of the present technology. In other words, for example, any other configurations or algorithms for purpose of practicing the present technology may be adopted.

When wording such as “substantially” or “about” is used in the present disclosure, such wording is merely used to facilitate the understanding of the description, and whether the wording such as “substantially” or “about” is used has no particular significance.

In other words, in the present disclosure, expressions, such as “center”, “middle”, “uniform”, “equal”, “similar”, “orthogonal”, “parallel”, “symmetric”, “extend”, “axial direction”, “columnar”, “cylindrical”, “ring-shaped”, and “annular” that define, for example, a shape, a size, a positional relationship, and a state respectively include, in concept, expressions such as “substantially the center/substantial center”, “substantially the middle/substantially middle”, “substantially uniform”, “substantially equal”, “substantially similar”, “substantially orthogonal”, “substantially parallel”, “substantially symmetric”, “substantially extend”, “substantially axial direction”, “substantially columnar”, “substantially cylindrical”, “substantially ring-shaped”, and “substantially annular”.

For example, the expressions such as “center”, “middle”, “uniform”, “equal”, “similar”, “orthogonal”, “parallel”, “symmetric”, “extend”, “axial direction”, “columnar”, “cylindrical”, “ring-shaped”, and “annular” also respectively include states within specified ranges (such as a range of +/−10%), with expressions such as “exactly the center/exact center”, “exactly the middle/exactly middle”, “exactly uniform”, “exactly equal”, “exactly similar”, “completely orthogonal”, “completely parallel”, “completely symmetric”, “completely extend”, “fully axial direction”, “perfectly columnar”, “perfectly cylindrical”, “perfectly ring-shaped”, and “perfectly annular” being respectively used as references.

Thus, an expression that does not include the wording such as “substantially” or “about” can also include, in concept, an expression including the wording such as “substantially” or “about”. Conversely, a state expressed using the expression including the wording such as “substantially” or “about” may include a state of “exactly/exact”, “completely”, “fully”, or “perfectly”.

In the present disclosure, an expression using “-er than” such as “being larger than A” and “being smaller than A” comprehensively includes, in concept, an expression that includes “being equal to A” and an expression that does not include “being equal to A”. For example, “being larger than A” is not limited to the expression that does not include “being equal to A”, and also includes “being equal to or greater than A”. Further, “being smaller than A” is not limited to “being less than A”, and also includes “being equal to or less than A”.

When the present technology is carried out, it is sufficient if a specific setting or the like may be adopted as appropriate from expressions included in “being larger than A” and expressions included in “being smaller than A”, in order to provide the effects described above.

At least two of the features of the present technology described above can also be combined. In other words, the various features described in the respective embodiments may be combined discretionarily regardless of the embodiments. Further, the various effects described above are not limitative but are merely illustrative, and other effects may be provided.

Note that the present technology may also take the following configurations.

(1) An information processing apparatus, including:

a first acquisition section that acquires map information;

a setting section that sets, on the basis of designation of a region that is performed by a user, a content region with which content data is associated;

a storage that stores therein the set content region and the map information in a state of being associated with each other; and

a display controller that causes the content region to be superimposed on the map information to be displayed.
(2) The information processing apparatus according to (1), further including:

a second acquisition section that acquires accuracy information regarding accuracy of position information acquired by a position sensor; and

an output section that outputs support information regarding the setting of the content region on the basis of the acquired accuracy information.

(3) The information processing apparatus according to (2), further including

a generator that generates the accuracy information on the basis of a difference between first position information and second position information, the first position information being set on the basis of the map information, the second position information being acquired by the position sensor at a position, in a real world, that corresponds to the first position information.

(4) The information processing apparatus according to (3), in which

the generator generates the accuracy information on the basis of a difference between path information and the position information, the path information being set on the basis of the map information, the position information being acquired by the position sensor in a path, in the real world, that corresponds to the path information.

(5) The information processing apparatus according to (4), in which

the support information includes image information that includes the map information, the image information being used to set at least one of the content region or the path information.

(6) The information processing apparatus according to (5), in which

the output section causes a correction region or a plurality of correction regions to be displayed on the map information in the image information, the correction region being based on the content region input on the basis of the map information, the plurality of correction regions being based on a plurality of the content regions input on the basis of the map information.

(7) The information processing apparatus according to (6), in which

the output section causes a region including the position information to be displayed as the correction region, the position information being likely to be acquired by the position sensor at a position, in the real world, that corresponds to a position situated in the input content region.

(8) The information processing apparatus according to (6) or (7), in which

when correction regions of the plurality of correction regions overlap, the output section changes at least one of a position or a size of each of the plurality of correction regions in order for the correction regions of the plurality of correction regions to no longer overlap.

(9) The information processing apparatus according to any one of (6) to (8), in which

the output section outputs alert information when correction regions of the plurality of correction regions overlap.

(10) The information processing apparatus according to any one of (6) to (9), in which

when correction regions of the plurality of correction regions overlap, the output section causes overlapping regions to be highlighted to be displayed.

(11) The information processing apparatus according to any one of (6) to (10), in which

when correction regions of the plurality of correction regions overlap, the output section outputs information regarding the content data associated with the content region corresponding to a corresponding one of the plurality of overlapping regions.

(12) The information processing apparatus according to any one of (5) to (11), in which

the output section outputs information regarding a scale of the map information.

(13) The information processing apparatus according to any one of (5) to (12), in which

the output section causes comparison-target information to be displayed on the image information, the comparison-target information including a set of the path information and the position information, the path information being set on the basis of the map information, the position information being acquired by the position sensor in the path, in the real world, that corresponds to the path information.

(14) The information processing apparatus according to (13), in which

the output section causes the comparison-target information to be superimposed on the map information in the image information.

(15) The information processing apparatus according to any one of (1) to (14), in which

the content data includes at least one of sound data or image data.

(16) The information processing apparatus according to any one of (1) to (15), in which

the position sensor is a GPS sensor.

(17) An information processing method that is performed by a computer system, the information processing method including:

acquiring map information;

setting, on the basis of designation of a region that is performed by a user, a content region with which content data is associated;

storing the set content region and the map information in a state of being associated with each other; and

causing the content region to be superimposed on the map information to be displayed.

(18) An information processing system, including:

a first acquisition section that acquires map information;

a setting section that sets, on the basis of designation of a region that is performed by a user, a content region with which content data is associated;

a storage that stores therein the set content region and the map information in a state of being associated with each other; and

a display section on which the content region is displayed in a state of being superimposed on the map information.

(19) A program that causes a computer system to perform a process including:

acquiring map information;

setting, on the basis of designation of a region that is performed by a user, a content region with which content data is associated;

storing the set content region and the map information in a state of being associated with each other; and

causing the content region to be superimposed on the map information to be displayed.

### REFERENCE SIGNS LIST

3 content region
6 creator
8 mobile terminal
9 server apparatus
10 information processing apparatus
13 first acquisition section
14 setting section
15 storage
16 display controller
26 generator
27 first acquisition section
28 output section
18 region setting GUI
52 path setting GUI
55 measurement path
57 result of actual measurement
58 margin region
59 correction region
70 computer
100 content creation system

1. An information processing apparatus, comprising:
a first acquisition section that acquires map information;
a setting section that sets, on a basis of designation of a region that is performed by a user, a content region with which content data is associated;
a storage that stores therein the set content region and the map information in a state of being associated with each other; and
a display controller that causes the content region to be superimposed on the map information to be displayed.

2. The information processing apparatus according to claim 1, further comprising:
a second acquisition section that acquires accuracy information regarding accuracy of position information acquired by a position sensor; and
an output section that outputs support information regarding the setting of the content region on a basis of the acquired accuracy information.

3. The information processing apparatus according to claim 2, further comprising
a generator that generates the accuracy information on a basis of a difference between first position information and second position information, the first position information being set on a basis of the map information, the second position information being acquired by the position sensor at a position, in a real world, that corresponds to the first position information.

4. The information processing apparatus according to claim 3, wherein
the generator generates the accuracy information on a basis of a difference between path information and the position information, the path information being set on the basis of the map information, the position information being acquired by the position sensor in a path, in the real world, that corresponds to the path information.

5. The information processing apparatus according to claim 4, wherein
the support information includes image information that includes the map information, the image information being used to set at least one of the content region or the path information.

6. The information processing apparatus according to claim 5, wherein
the output section causes a correction region or a plurality of correction regions to be displayed on the map information in the image information, the correction region being based on the content region input on a basis of the map information, the plurality of correction regions being based on a plurality of the content regions input on the basis of the map information.

7. The information processing apparatus according to claim 6, wherein
the output section causes a region including the position information to be displayed as the correction region, the position information being likely to be acquired by the position sensor at a position, in the real world, that corresponds to a position situated in the input content region.

8. The information processing apparatus according to claim 6, wherein
when correction regions of the plurality of correction regions overlap, the output section changes at least one of a position or a size of each of the plurality of correction regions in order for the correction regions of the plurality of correction regions to no longer overlap.

9. The information processing apparatus according to claim 6, wherein
the output section outputs alert information when correction regions of the plurality of correction regions overlap.

10. The information processing apparatus according to claim 6, wherein
when correction regions of the plurality of correction regions overlap, the output section causes overlapping regions to be highlighted to be displayed.

11. The information processing apparatus according to claim 6, wherein
when correction regions of the plurality of correction regions overlap, the output section outputs information regarding the content data associated with the content region corresponding to a corresponding one of the plurality of overlapping regions.

12. The information processing apparatus according to claim 5, wherein
the output section outputs information regarding a scale of the map information.

13. The information processing apparatus according to claim 5, wherein
the output section causes comparison-target information to be displayed on the image information, the comparison-target information including a set of the path information and the position information, the path information being set on the basis of the map information, the position information being acquired by the position sensor in the path, in the real world, that corresponds to the path information.

14. The information processing apparatus according to claim 13, wherein
the output section causes the comparison-target information to be superimposed on the map information in the image information.

15. The information processing apparatus according to claim 1, wherein
the content data includes at least one of sound data or image data.

16. The information processing apparatus according to claim 1, wherein
the position sensor is a GPS sensor.

17. An information processing method that is performed by a computer system, the information processing method comprising:
acquiring map information;
setting, on a basis of designation of a region that is performed by a user, a content region with which content data is associated;
storing the set content region and the map information in a state of being associated with each other; and
causing the content region to be superimposed on the map information to be displayed.

18. An information processing system, comprising:
a first acquisition section that acquires map information;
a setting section that sets, on a basis of designation of a region that is performed by a user, a content region with which content data is associated;
a storage that stores therein the set content region and the map information in a state of being associated with each other; and
a display section on which the content region is displayed in a state of being superimposed on the map information.
